(19) United States
(12) Patent Application Publication
(10) Pub. No.: US 2004/0129481 A1
(43) Pub. Date: Jul. 8, 2004

(54) Sprint car torque ball housing and starter mount

(76) Inventor: Kenneth R. Stolfus, Lee's Summit, MO (US)

Correspondence Address: Sean T. Bradley, Chase Law Firm, L.C., Suite 130, 4400 College Boulevard, Overland Park, KS, 66211, US

(21) Appl. No.: 10/741,265

(22) Filed: Dec. 19, 2003

Related U.S. Application Data
(60) Provisional application No. 60/436,142, filed on Dec. 23, 2002.

(51) Int. Cl. B60K 5/00

(52) U.S. Cl. 180/291; 180/312

(57) ABSTRACT

An integral torque ball housing and starter mount for use with a motorized vehicle starter system.

### CROSS REFERENCE TO RELATED APPLICATION

This application claims the benefit of the prior filed, co-pending provisional application Serial No. 60/436,142, filed Dec. 23, 2002.

### FIELD OF THE INVENTION

This invention relates to a cockpit-mounted starter system for a sprint car, and more particularly to a torque ball housing and starter mount for use with a sprint car starter system.

### BACKGROUND OF THE INVENTION

Because most sprint cars are composed of the same materials, constructed in a similar way and powered by similar engines, a significant factor to vehicle performance during a race is the overall weight of the vehicle. Sprint cars are, therefore, constructed so as to minimize weight. This includes using lightweight materials such as thin chromium molybdenum steel to construct the frame, and aluminum and titanium for other elements. In addition, sprint cars traditionally do not have a clutch, transmission, battery or starter. When possible, weight is distributed to the rear of the vehicle to offset the weight of the engine, which is mounted forward of the cockpit.

Since sprint cars do not use a transmission, they typically do not have a flywheel-pressure plate and clutch assembly and, therefore, do not have a bell housing. The driveline is enclosed within a torque tube that extends from the rear of the vehicle to the engine plate and includes a torque ball and socket to allow suspension travel. A simple engagement mechanism allows the driveline to be engaged or disengaged with the engine drive shaft. Since a typical sprint car does not have a clutch, prior to starting the engine a sprint car must be put into gear, and then pushed by a truck or other vehicle to a relatively high rate of speed. While the sprint car is being pushed, the driver monitors the oil pressure. When an optimum pressure is achieved, a switch is thrown allowing electric current to flow from a magneto to the engine spark plugs, thereby enabling combustion to initiate.

### BRIEF SUMMARY OF THE INVENTION

The present invention overcomes the above problems in the prior art by providing an integrated torque ball housing and starter mount. An important object is to provide a starter mount and integral torque ball housing for a sprint car that may be easily installed with minimal adjustments or changes required to a common sprint car configuration.

Another object of the present invention is to provide a starter mount for the starter system of a sprint car, which renders the operation of sprint car races safer for the drivers and track personnel by eliminating the need for push trucks on the track during a race.

Another object is to provide a starter mount and integral drive end housing for a sprint car whereby the weight is distributed rearward of the engine compartment.

Still another object of the present invention is to provide a combination torque ball housing and starter mount for a sprint car wherein the flywheel is of reduced size, thereby minimizing weight, rotary inertia, and the space required to house the rotating engine and driveline components.

Yet another object is to provide a compartment for housing the starter pinion assembly whereby said assembly is protected from dirt, dust, debris and moisture while in operation.

In furtherance of the foregoing, the torque ball housing and starter mount may contain a flywheel positioned rearward of the engine compartment and forward of the cockpit, a crank shaft connection to the driveline, and a drive shaft connecting the flywheel to the rear wheels of the vehicle, the starter having a pinion gear engageable with the flywheel for rotating the flywheel and starting the engine. The flywheel is of a reduced size to minimize the vehicle weight and to facilitate placement of the flywheel in a space provided behind the engine block and torque ball housing or within the torque ball housing.

The torque ball housing and starter mount allows the starter to be mounted to the driveline component eliminating the need for a full length rear engine plate. The rear engine plate in some sprint cars ends just below the torque ball housing. The integral torque ball housing and starter mount provided herein may be readily mounted to such plates, making the mount universal to sprint cars that use a torque ball driveline.

The housing allows standard sprint car, cam-driven, power steering and fuel pumps to be used. The pumps mount above the housing and a reduced size flywheel clear the pump's camshaft drive assembly. The housing in conjunction with the flywheel also allows the use of a gear driven pump in mesh with the flywheel, eliminating the need to drive the pumps off the back of the cam. This is an advantageous feature of having the flywheel mounted to the crankshaft and is therefore an advantage that may be provided by the present invention. The flywheel driven pumps reduce the torque load on the camshaft. The gear driven mesh with the flywheel therefore may provide an advantage over cam-driven pumps.

### BRIEF DESCRIPTION OF THE DRAWINGS

FIG. 1 is a front elevation of a torque ball housing and starter mount (housing) in accordance with the present invention;

FIG. 2 is a side elevation of the housing of FIG. 1;

FIG. 3 is an bottom view of the housing of FIG. 1;

FIG. 4 is a perspective view of the housing of FIG. 1;

FIG. 5 is a front elevation of an alternative embodiment of a torque ball housing and starter mount in accordance with the present invention;

FIG. 6 is a side elevation of the housing of FIG. 5;

FIG. 7 is an bottom view of the housing of FIG. 5;

FIG. 8 is a perspective view of the housing of FIG. 5;

FIG. 9 is an environmental perspective view of the torque ball housing and starter mount of FIGS. 1 to 4;

FIG. 10 is a diagram of a sprint car;

FIG. 11 is an enlarged cut-away diagram of the interior of a sprint car to reveal details of the torque ball housing and starter mount as installed within the cockpit of a sprint car;

FIG. 12 is an enlarged, partial, side elevation showing a portion of the forward drive-train assembly including the crankshaft, flywheel, U-joint, torque ball housing and starter mount, starter, and driveshaft;

FIG. 13a is a side elevation of an alternative embodiment of a housing in accordance with the present invention with portions broken away to show the flywheel mounted within the housing;

FIG. 13b is a side elevation of an alternative embodiment to the housing of FIG. 13a including an intermediate gear interposed between the pinion and flywheel; FIG. 13c is a side elevation of an alternative embodiment to the housing of FIG. 13b including an two intermediate gears interposed between the pinion and flywheel;

FIG. 14 is a front perspective view of the starter mount plate and alternative tubular engine mount system.

### DETAILED DESCRIPTION

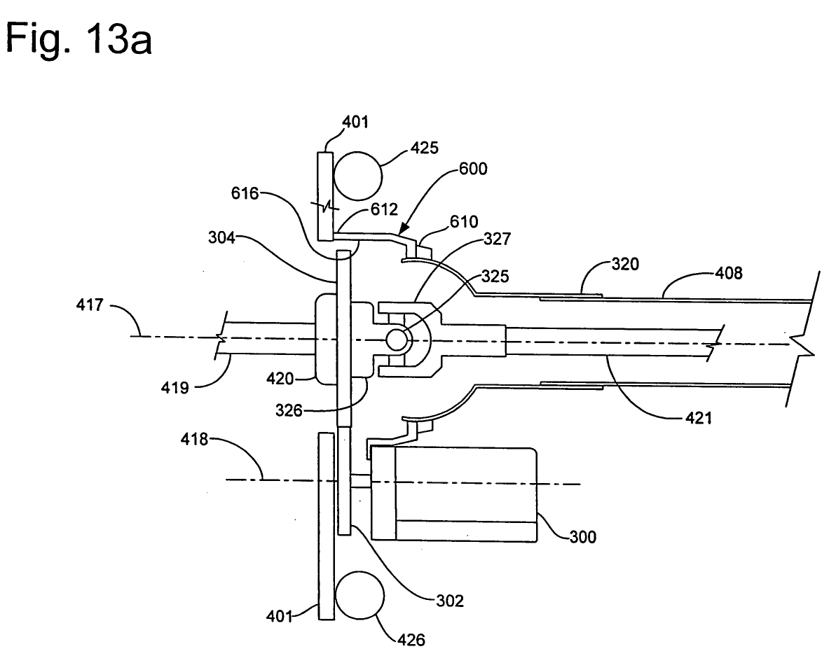

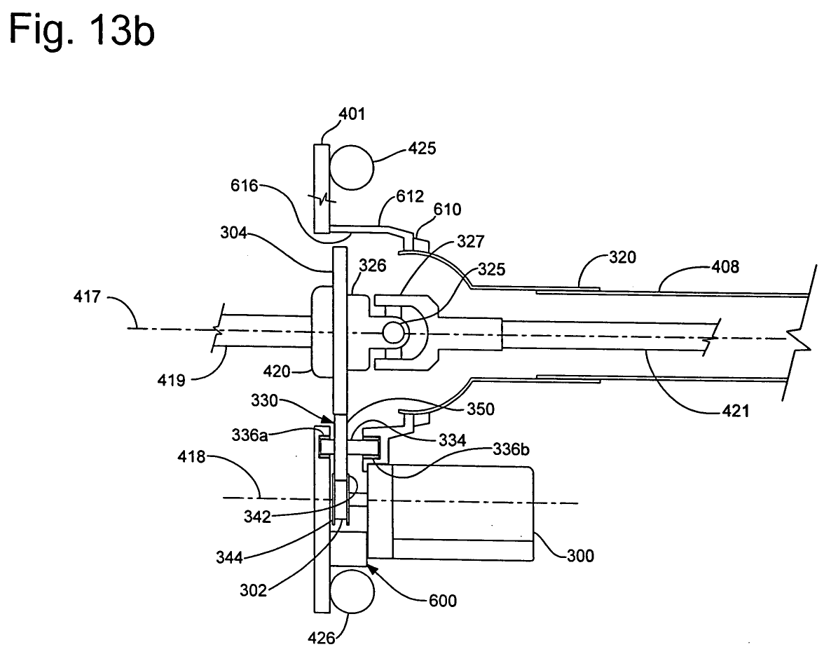

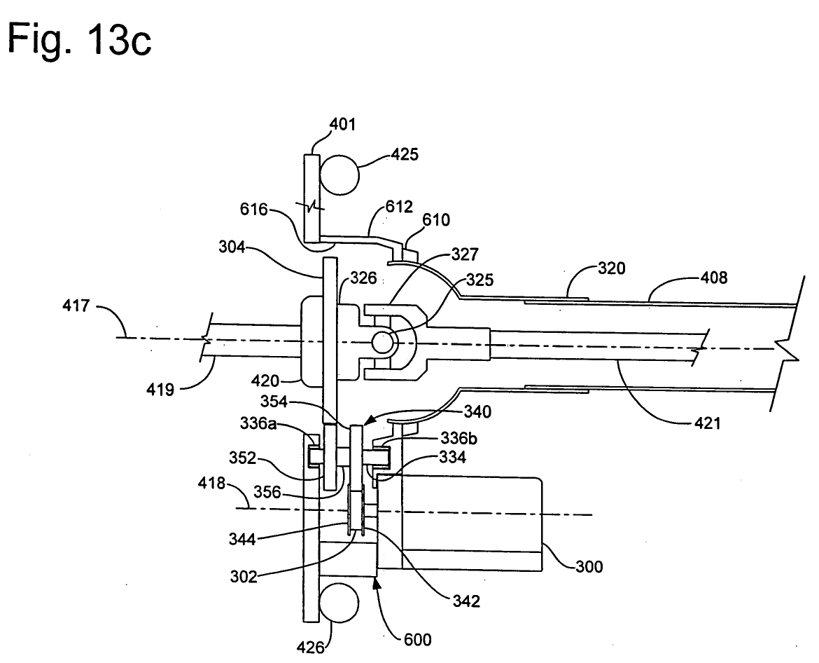

Turning to the figures, FIG. 1 is a front elevation of a torque ball housing and starter mount 100 (housing) in accordance with the present invention. The housing 100 includes two contiguous major elements: a housing ring 110 and a starter mount 150. The housing ring 110 includes a torque ball flange 112. The housing ring 110 and torque ball flange 112 form a circular ring enclosing a torque ball chamber 116. The U-joint (325, 326, 327) of a sprint car drive train is housed within the torque ball chamber 116 (see FIGS. 13a to 13c).

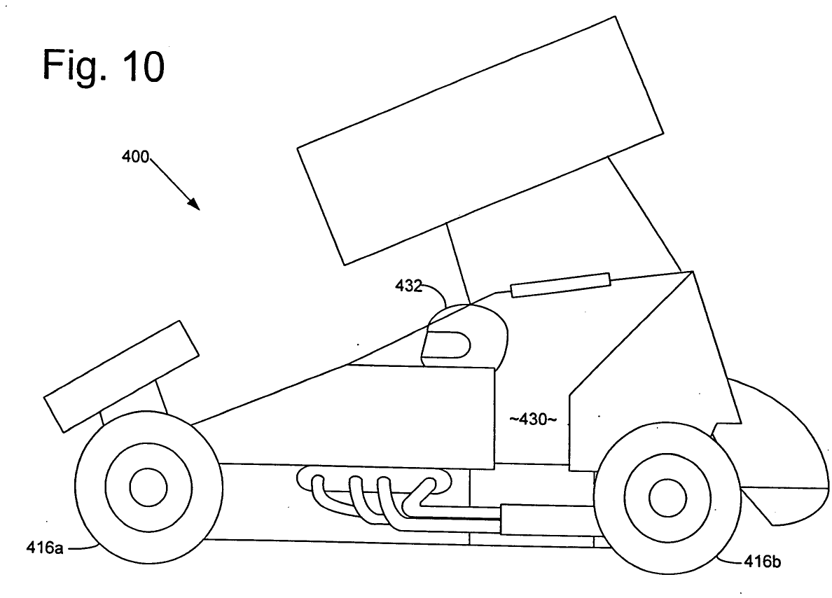

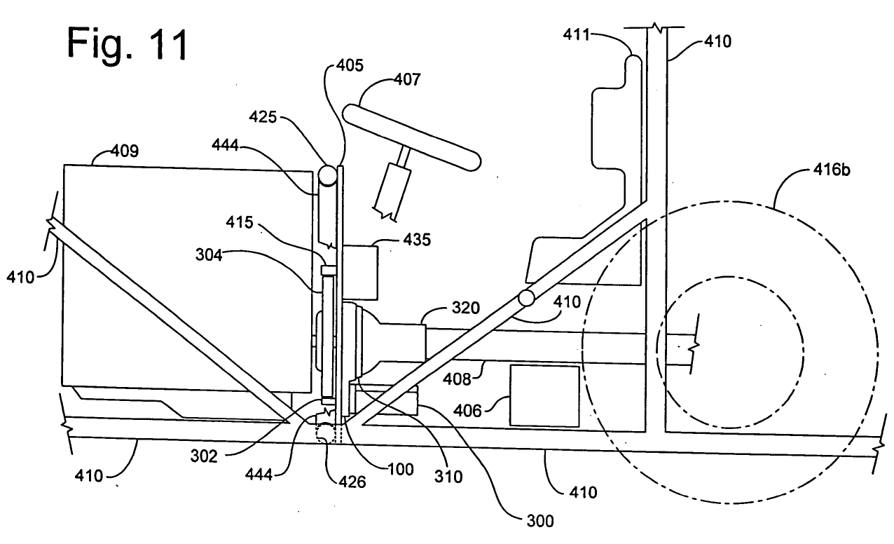

FIGS. 10 and 11 provide environmental illustrations, showing an overall diagram of a sprint car and an enlarged diagram of the interior of a sprint car. FIG. 10 is a simple diagram of a common sprint car 400 showing placement of the cockpit 430, driver 432, and front 416a and back 416b wheels for reference. FIG. 11 is an enlarged cut-away diagram of the interior of a sprint car 400 showing the housing 100 mounted for operation. Other common elements of a sprint car 400 are illustrated for reference including the steering wheel 407, seat 411, battery 406 and wheel 416b (drawn in phantom lines). The housing 100 is located within the cockpit 430 and mounted on a starter mount plate 405. The starter mount plate 405 defines the front wall of the cockpit 430 and is attached to the chassis 410 by the front cockpit frame rails 425 and 426 (see FIG. 11).

Returning to FIG. 1, the torque ball flange 112 is provided with engine plate bolt holes 117a through 117d for attaching the torque ball flange 112 to the starter mount plate 405. The starter mount flange 152 also includes engine plate bolt holes 117e and 1117f. Bolts may pass through bolt holes 117e and 117f to further secure the housing 100 to the starter mount plate 405. It should be appreciated that since the housing ring portion 110 and starter mount portion 150 are contiguous, engine plate bolt holes 117e and 117f may be omitted. Preferably, the housing 100 is formed from a single, machined piece of rigid material such as aluminum or aluminum and magnesium alloy.

The starter mount flange 152 also includes starter bolt holes 160 and 162. Bolts are threaded into these holes 160 and 162 to attach a starter 300 to the starter mount flange 152. FIG. 11 illustrates a starter 300 in operative position attached to the housing 100. The starter mount flange 152 is provided with a starter pinion aperture 156 to receive the pinion projecting from the starter 300.

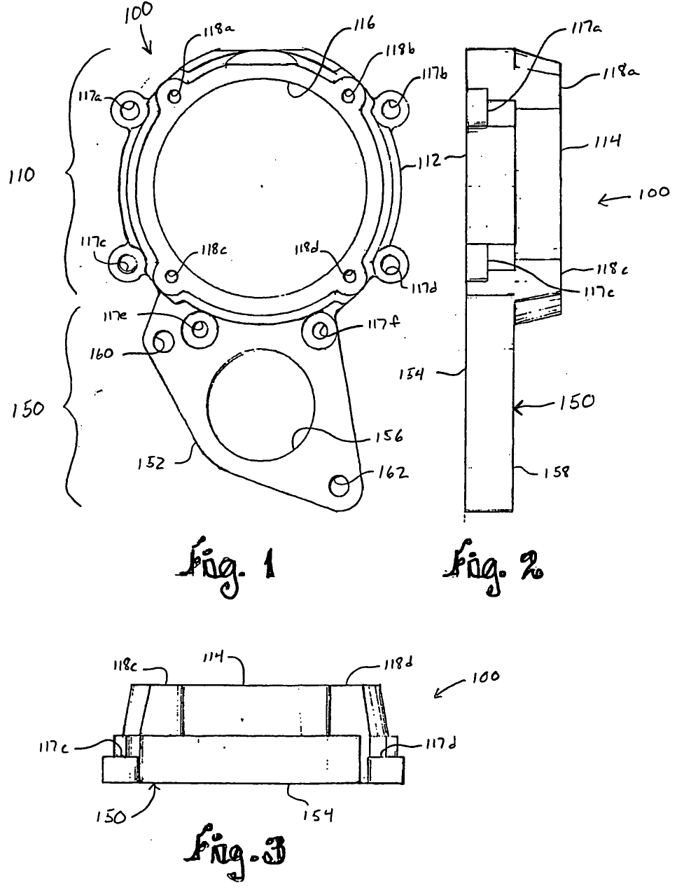

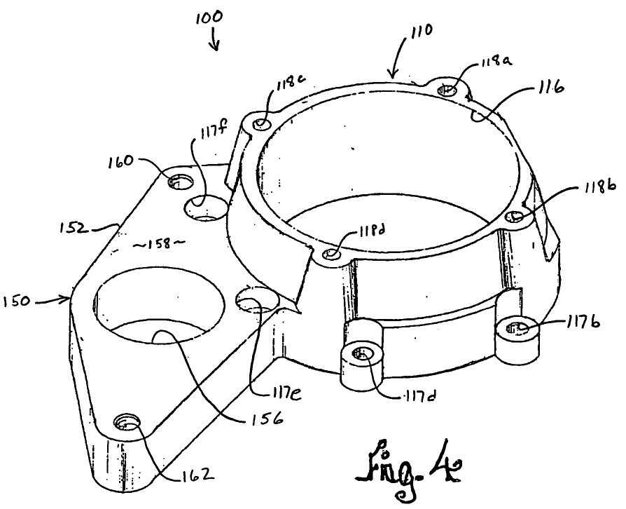

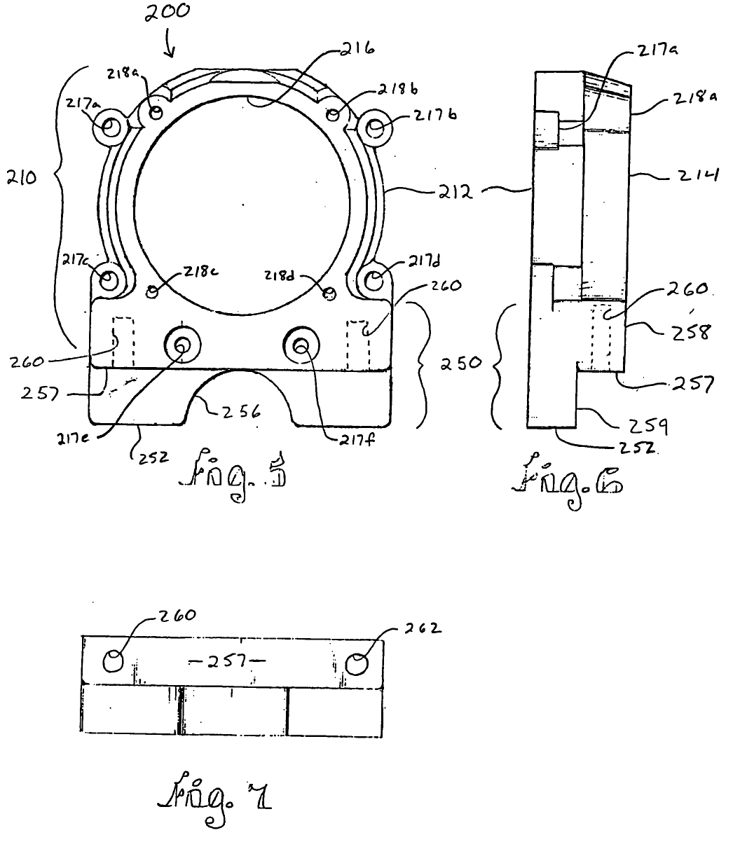

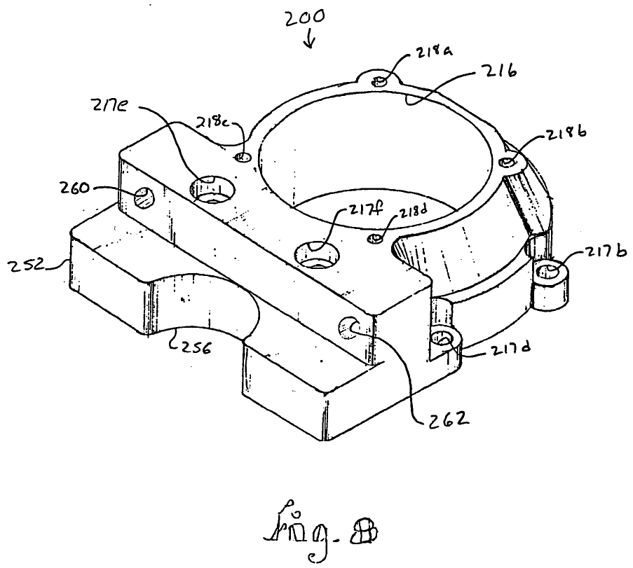

FIG. 2 is a side elevation of the housing 100, viewed from the left side of the housing illustrated in FIG. 1. FIG. 2 illustrates the approximate overall thickness of the housing 100 as well as the relative thickness of the housing ring portion 110 to the starter mount portion 150. The retaining ring 310 mounts against the retaining ring mount surface 114 shown in FIGS. 2 and 3. The starter 300 mounts against the starter mount surface 158, also shown in FIG. 2. FIG. 3 is a bottom view of the housing 100 showing the starter mount portion 150 in the lower foreground. FIG. 4 is a perspective view of the housing 100 shown in FIGS. 1, 2 and 3, illustrating the inner walls of the torque ball chamber 116 and pinion aperture 156.

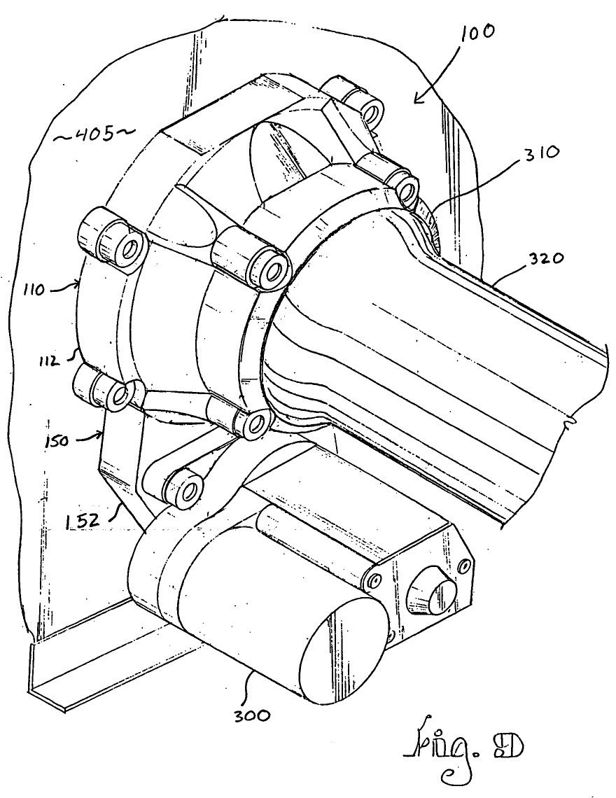

FIGS. 5 through 8 illustrate an alternative embodiment of a torque ball housing and starter mount 200 in accordance with the present invention. As with the preferred embodiment 100 this alternative embodiment 200 includes a housing ring portion 210 and a starter mount portion 250. The torque ball flange 212 includes engine plate mounting bolts 217a through 217f. Retaining ring bolt holes 218a through 218d are also provided for attachment of the retaining ring 310. The primary difference between this alternative embodiment 200 and the preferred embodiment 100 is the configuration of the starter mount flange 252. The starter bolt holes 260 are oriented perpendicular to those 160 of the preferred embodiment, in order to accommodate side mounting starters (not shown). A starter pinion recess 256 is provided to accept the pinion of the side mounting starter. The starter is mounted to the starter mount flange 252 by threading bolts into the starter bolt holes 260 and tightening the body of the starter against flange wall 257 and flange surface 259. The housing ring portion 210, including the torque ball flange 212, forms a circular ring enclosing a torque ball chamber 216.

FIG. 9 is a perspective view of the housing 100 of FIGS. 1 through 4, as viewed when looking down into the cockpit of a sprint car 400. FIG. 9 shows the torque ball 320 attached to the torque ball flange 112 by the retaining ring 310. FIG. 9 also shows the starter 300 attached to the starter mount flange 152.

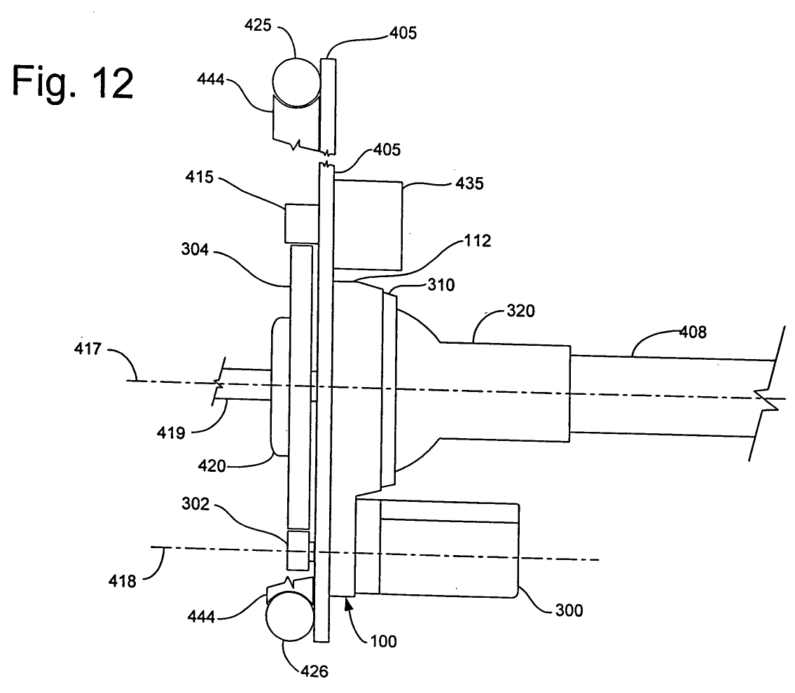

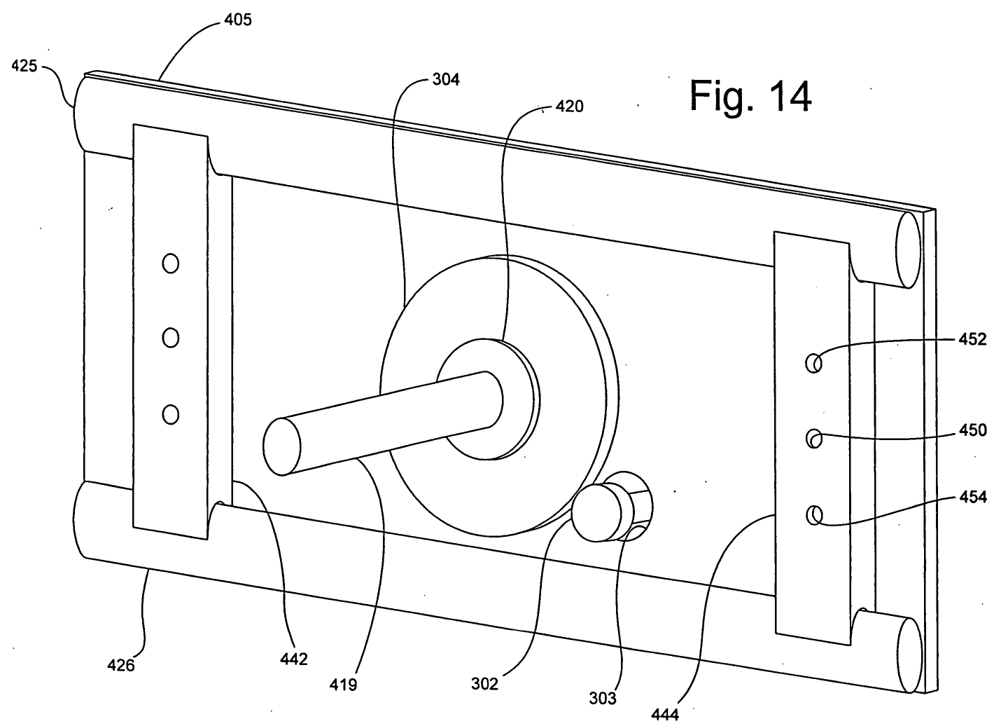

FIG. 11 shows the sprint car engine 409 located within the chassis 410 of the sprint car and forward of the cockpit 430. The engine is secured to a tubular engine mount system 440 comprising tubular engine mounts 442 and 444, which are attached to chassis tubes 425 and 426 (see FIG. 14). Tubular engine mount 444 is shown in FIG. 11 and is broken away to reveal the flywheel 304, the pinion 302 and an auxiliary gear 415. The auxiliary gear 415 is turned by the flywheel 304 to power components such as a fuel pump 435. Rearward of the tubular engine mount 444 is the starter mount plate 405. The starter mount plate 405 is bolted to the chassis 410, including chassis tubes 425 and 426, or otherwise fastened by means known in the art. The housing 100 is mounted on the starter mount plate 405. A crank shaft 419 (shown in FIG. 12) extends from the engine 409 to the flywheel 304.

FIG. 12 is an enlarged, partial, side elevation showing the forward drive train assembly including the housing 100, starter 300, retaining ring 310 and flywheel 304. As shown, the pinion 302 of the starter 300 projects forward of the starter mount plate 405 to engage the flywheel 304. The flywheel 304 is attached to the crank shaft 419 and in communication with the starter pinion 302. Dashed lines 417 and 418 indicate the axes of rotation for the crank shaft 419 and starter pinion 302, respectively.

FIGS. 11 and 12 also illustrate the relative positions of the torque ball 320 and torque tube 408. The torque ball 320 is held in place against the retaining ring mount surface 114 of the torque ball flange 112. The torque ball 320 is fixed in place against the surface 114 by a torque ball retaining ring 310. The torque ball retaining ring 310 is attached to the torque ball flange 112 using bolts that are threaded into retaining ring bolt holes 118a through 118d.

A flywheel 304 diameter of 4½ to 8½ inches is preferable. The perimeter of the flywheel 304 is provided with gear teeth indexed to mesh with the teeth on the starter pinion 302 (gear teeth not shown). In the embodiment illustrated in FIG. 12, the flywheel 304 has a 10 diametral pitch and approximately an 8 inch outer diameter. The flywheel 304 is typically attached to the crankshaft 419 by means of a crankshaft flange 420 typically provided with an engine 409 (see FIGS. 11 to 13c).

The housing 100 allows standard sprint car cam-driven power steering and fuel pumps to be used. The housing 100 may also allow the use of a gear driven pump 435 in mesh with the flywheel 304, eliminating the need to drive the pumps off the back of the cam. The power steering, fuel and or oil pumps 435 may incorporate gears 415 to engage the flywheel 304. Flywheel driven pumps reduce the torque load on the camshaft 419 providing a definite advantage over the cam driven style pumps. The U-joint flange 326 is attached with through-bolts that fasten the flywheel 304, and U-joint (325, 326, 327) to the back of the crankshaft flange 420. Power is thereby transmitted from the engine 409 to the drive shaft 421.

The starter motor 300 and solenoid (not shown) are mounted within the cockpit below the torque ball 320. The solenoid is mounted in proximity to the starter 300 and is operated by a known type of starter control circuit. The solenoid is connected to the starter 302 pinion for sliding the pinion 302 a predetermined distance to engage the pinion 302 with the flywheel 304. When the electrical supply to the starter motor 300 is stopped, the solenoid is no longer activated and the pinion 302 recedes into its housing, thereby disengaging the pinion 302 from the flywheel 304 during normal engine operation.

The starter 300 is then connected, using appropriate wiring, to a battery 406 located underneath the driver's seat 411. A switch (not shown) is provided with the starter wiring assembly and is mounted within the cockpit 430. This cockpit mounting location places the starter 300 and associated electrical components in a location where they are less exposed to dirt, dust and moisture from the track, and where they can be easily serviced.

FIGS. 13a to 13c illustrate alternative embodiments of a torque ball housing and starter mount 600 (housing 600) by which the flywheel 304 may be enclosed within the housing 600. FIG. 13a shows a housing 600, retaining ring 610, torque ball 320, torque tube 408, rear engine mount plate 401, and chassis tubes 425 and 426, broken away to reveal the crankshaft 419, crankshaft flange 420, flywheel 304, and U-joint flange 326. The latter four elements are secured to one another, in the orientation shown, the crankshaft flange 420 typically being welded to the crankshaft 419, and the flywheel 304 and U-joint flange 326 typically being secured to the crankshaft flange 420 by through-bolts (not shown). The U-joint flange 326 is rotatably attached to the yoke 327 via a pivot 325. The yoke 327 is secured to the drive shaft 421.

The housings 600 shown in FIGS. 13a to 13c differ from the embodiment shown in FIGS. 11 and 12 primarily in that the flywheel 304 is housed within an extended torque ball chamber 616 formed by lengthening the walls of the housing 600. In order to fit within the housing 600, the flywheel 304 has been reduced in diameter and has approximately 50 teeth. Notably, the housing 600 can now be attached directly to the existing rear engine mount plate 401.

In FIG. 13a, the pinion 302 has been increased in diameter to meet the outer perimeter of the flywheel 304. In order to meet the increased power demand created by this altered gear ratio, a starter 300 having a 3.0 kilowatt (or greater) motor would be preferred.

FIG. 13b illustrates an embodiment utilizing an intermediate gear system 330. An intermediate gear 350 transmits rotational power from the starter pinion 302 to the flywheel 304. The intermediate gear 350 rotates freely upon a shaft 334 that is housed within bearings 336 fitted into spaces provided in the rear engine mount plate 401 and housing 600. So that the intermediate gear 350 can be disengaged from the flywheel 304 once the engine 409 is started, the intermediate gear 350 is provided with means for selectively sliding along the axis of shaft 334. The means illustrated in FIG. 13b includes rotatable fixation to the pinion 302 via washers 342 and 344. The intermediate gear 350 is sandwiched between the washers 342 and 344 so that it moves with the pinion 302 as the pinion 302 is extended and retracted by the starter 300 solenoid. Typical dimensions for the flywheel 304, intermediate gear 350 and pinion 302 are 50, 15 and 9 teeth, respectively.

FIG. 13c illustrates yet another embodiment, similar in function to that shown in FIG. 13b, wherein the intermediate gear system 340 comprises two intermediate gears, a driving gear 352 and a driven gear 354. The driven gear 354 is sandwiched between pinion washers 342 and 344 and is fixed to the driving gear 352 by means of a collar 356. Alternatively, the intermediate gears 352 and 354 and collar 356 may be formed as one piece. The driven gear 354 is powered by the pinion 302. The driving gear 352 is powered by the driven gear 354 and transmits power to the flywheel 304. As the pinion 302 is extended and retracted, the driven gear 354 is moved along the axis of the shaft 334 and the driving gear 352 is engaged or disengaged, respectively, from the flywheel 304.

FIGS. 11 and 12 show the housing 100 attached to the starter mount plate 405 which is secured to horizontal chassis tubes 425 and 426. The figures also show a portion of tubular engine mount 444, which is also attached to starter mount plate 405. Tubular engine mount 444 shown broken away to reveal underlying details. The torque ball 320 is retained partially within the housing 100 by means of a retaining ring 310 which is secured to the housing 100. A torque tube 408 is positioned within the cylindrical rear portion of the torque ball 320. As shown in FIGS. 13a to 13c, the torque tube 408 covers the rotating drive shaft 421.

FIG. 14 illustrates a front perspective view of the starter mount plate 405 and alternative tubular engine mount system comprising tubular engine mounts 442 and 444, attached to chassis tubes 425 and 426. The illustration includes the flywheel 304, outside of the starter mount plate 405 as shown in side view in FIG. 12, the crankshaft 419 and crankshaft flange 420. The pinion 302 is shown engaged with the flywheel 304 and projecting through aperture 303 in the starter mount plate 405. Engine bolt holes 452 and 454 are provided in each tubular engine mount to receive bolts used to bolt the engine 409 to the tubular engine mounts 442 and 444. A tapered dowel pin hole 450 is provided in each tubular engine mount to accept a tapered engine dowel pin (not shown).

It is to be understood that while certain forms of this invention have been illustrated and described, it is not limited thereto except insofar as such limitations are included in the following claims and allowable equivalents thereof.

Having thus described the invention, what is claimed as new and desired to be secured by Letters Patent is:

1. A housing for forming an integrated torque ball housing and starter mount, said housing comprising:
a housing ring,
a torque ball flange projecting substantially radially outward from said ring, said housing ring and torque ball flange cooperating to form a torque ball chamber,
a starter mount comprising a starter mount flange depending from said torque ball flange, said starter mount flange including means for receiving a starter motor pinion.

2. The housing of claim 1, wherein said means for receiving a starter motor pinion comprises an aperture within said starter mount flange.

3. The housing of claim 1, wherein said means for receiving a starter motor pinion comprises a recess on said starter mount flange.

4. An integrated torque ball housing and starter mount system comprising:
a planar, vertically oriented plate attached to a vehicle chassis and between an engine compartment and a cockpit, said plate having a forward surface facing said engine compartment and a rearward surface facing said cockpit,
a housing comprising,
a housing ring,
a torque ball flange projecting substantially radially outward from said ring, said housing ring and torque ball flange cooperating to form a torque ball chamber,
a starter mount comprising a starter mount flange depending from said torque ball flange, said starter mount flange including means for receiving a starter motor pinion,
said housing attached to said rearward surface of said plate.

5. The system of claim 4, wherein said starter mount flange includes means for mounting a starter motor to said starter mount flange.

6. The system of claim 4, wherein said means for receiving a starter motor pinion comprises an aperture in said starter mount flange.

7. The system of claim 4, wherein said means for receiving a starter motor pinion comprises a recess in a side of said starter mount flange.

8. In combination with a wheeled racing vehicle powered by internal combustion, a starter system with integrated torque ball housing and starter mount comprising:
a vehicle including a chassis, an engine compartment located in a forward portion of said chassis, an engine located in said engine compartment and attached to said chassis, a cockpit compartment located rearward of said engine compartment.
a planar, vertically oriented rear motor mount plate attached to said chassis between said engine compartment and said cockpit and dividing said engine compartment from said cockpit, said mount plate having a forward surface facing said engine compartment and a rearward surface facing said cockpit,
a housing comprising,
a housing ring,
a torque ball flange projecting substantially radially outward from said ring, said housing ring and torque ball flange cooperating to form a torque ball chamber,
a starter mount comprising a starter mount flange depending from said torque ball flange, said starter mount flange including a pinion aperture,
said housing attached to said rearward surface of said mount plate,
a starter motor attached to a rearward surface of said starter mount, said starter motor including a pinion adapted to project forwardly through said pinion aperture and further through an opening in said mount plate toward said engine compartment,
a power source connected to said starter motor for providing electrical power to said starter motor,
a flywheel mounted on a engine powered shaft, said flywheel positioned rearward of said engine and in close proximity to and parallel alignment with said mount plate, the outer circumferential surface of said flywheel engaged with said pinion,
a drive shaft in communication with said flywheel and extending rearward, connecting with the rear wheels of said vehicle, and
means for engaging the starter motor by initiating supply of electrical power from said power source to said starter motor.

9. The starter system of claim 8, wherein said flywheel is engaged with said pinion by means of an intermediate gear placed between said flywheel and said pinion, whereby rotation force is transmitted from said pinion to said intermediate gear and then to said flywheel.

10. The starter system of claim 9 further comprising means for selectively engaging and disengaging said intermediate gear from said pinion.

11. The starter system of claim 9 further comprising means for selectively engaging and disengaging said intermediate gear from said flywheel.

12. The starter system of claim 8, wherein said flywheel is engaged with said pinion by means of an intermediate gear system comprising one or more intermediate gears placed between said flywheel and said pinion, and in rotational communication with said flywheel and said pinion, whereby rotation force may be transmitted from said pinion to said intermediate gears and then to said flywheel.
